(19) United States
(12) Patent Application Publication
(10) Pub. No.: US 2002/0102989 A1
(43) Pub. Date: Aug. 1, 2002

(54) Method and apparatus for accurately locating a communication device in a wireless communication system

(76) Inventors: Brian Edward Calvert, Austin, TX (US); Jason David Mann, Georgetown, TX (US); Jheroen Pieter Dorenbosch, Paradise, TX (US)

Correspondence Address: Motorola, Inc., Intellectual Property Section, Law Department, 1500 Gateway Blvd, Boynton Beach, FL, 33426-8292, US

(21) Appl. No.: 09/769,939

(22) Filed: Jan. 26, 2001

(51) Int. Cl. H04Q 7/20

(52) U.S. Cl. 455/456; 455/414; 455/457

(57) ABSTRACT

A wireless communication system employs a method and apparatus for accurately locating a communication device in the system. The communication system includes a system infrastructure that provides communication services to communication devices distributed throughout the communication system. Either on its own or, more preferably, responsive to a request from a requesting device for an accurate location of a particular communication device, the system infrastructure determines an approximate geographic location of the communication device. Based on the approximate location, the infrastructure transmits a request to the communication device for a more accurate location of the device preferably together with a map of an area that includes the approximate location of the device. The communication device preferably displays at least the map to a user of the device and, responsive to user input, transmits the more accurate location of the device to the system infrastructure. After receiving the more accurate location, the system infrastructure conveys the location to a target device preferably identified in the original location request received by the infrastructure.

### FIELD OF THE INVENTION

The present invention relates generally to locating communication devices in wireless communication systems and, in particular, to a method and apparatus for accurately geographically locating a communication device in a wireless communication system.

### BACKGROUND OF THE INVENTION

Wireless communication systems are well known and include various types of systems, such as cellular telephone systems, paging systems, two-way radio systems, personal communication systems, data systems, and various combinations thereof. Such wireless systems are known to include a system infrastructure and communication devices constructed and programmed to operate in the respective system. The system infrastructure includes fixed network equipment, such as base transceiver sites (BTSs), system controllers, switches, routers, communication links, antenna towers, and various other known infrastructure components.

Certain wireless systems include the capability, either inherently or specially, to locate communication devices within the systems with varying degrees of accuracy. For example, a cellular system inherently includes the capability to coarsely locate a registered cellular telephone either within a so-called paging location area (e.g., a group of cells or BTS coverage areas)—when the cellular telephone is not actively engaged in a communication—or within a cell or BTS coverage area—when the cellular telephone is actively engaged in a communication. A cellular system must be able to locate cellular telephones with the aforementioned accuracies to enable the telephones to properly receive and place telephone calls.

Other systems have been proposed to enable more accurate locating of wireless devices in the event of an emergency or simply for the purposes of continually monitoring the locations of the devices (e.g., in public safety systems). Such other systems either incorporate global positioning satellite (GPS) receivers in the wireless devices or use triangulation techniques to approximately locate the devices.

In systems that incorporate GPS receivers in the wireless devices, each wireless device automatically determines its own location based on the receipt of signals from multiple satellites in the GPS system and transmits the location to the system infrastructure either as requested by the system infrastructure or periodically. The horizontal (latitude and longitude) accuracy of the GPS location determination is relatively precise (e.g., within three meters to ten meters of the device's actual location); however, the vertical accuracy is typically only 1.6 times as accurate as the horizontal accuracy (e.g., only within five meters to sixteen meters of the device's actual location). In addition, GPS systems do not provide accurate measurements when the device is inside a building or is in any other area, such as in an urban location surrounded by multiple, adjacent high rise buildings, having obscured access to the orbiting global positioning satellites. Therefore, if the user of a wireless device was located on the seventh floor of a high rise building and needed emergency attention or someone desired to personally meet the user (e.g., to deliver a high priority package to the user), the emergency personnel or other person could not rely on the location provided by the device's GPS unit or, even if they could rely on the location, would not likely realize the user was on the seventh floor.

Besides having poor vertical accuracy and in-building performance, GPS technology is still relatively expensive when compared to the cost of a typical wireless device, such as a cellular telephone, two-way radio, or two-way pager. The inclusion of GPS technology in such devices requires extensive hardware additions and modifications and, therefore, can increase the cost of such devices by as much as fifty percent (50%) or more, thereby rendering such GPS-inclusive communication devices unaffordable to many people.

In systems that utilize triangulation techniques to locate wireless communication devices, either the system infrastructure or the wireless device measures the time differences of arrival of signals from the other and uses the time differences of arrival to determine the device's approximate location. For example, the wireless device may receive time-synchronized signals from three or more BTSs and compute the time differences of arrival of the signals using known techniques. The device may then compute its own location (if the device includes a database containing the actual locations of the BTSs from which it received the signals) or, more likely, transmit the computed time differences of arrival to the system infrastructure for the location determination. Alternatively, three or more BTSs may receive a signal from the wireless device, determine the signal's arrival times, and forward the arrival times to the system controller for determination of time differences of arrival and, ultimately, the approximate location of the wireless device.

Although triangulation techniques are less expensive than GPS technology because they require primarily software modifications to the wireless devices and system infrastructure, they are not as accurate. The typical accuracy of triangulation techniques is only within a couple hundred meters.

Recently, the Federal Communications Commission (FCC) issued a requirement that all cellular service providers within the United States must provide by October 2001 the capability to locate the position of a cellular telephone placing an emergency 911 call to within one hundred twenty-five (125) meters with about sixty-seven percent (67%) probability. Consequently much research and development is currently underway to determine advances in triangulation techniques to meet the FCC requirements. However, even systems that meet the FCC mandate are much less accurate than those having wireless devices incorporating GPS technology and are not really accurate enough to enable a personal meeting with a user of the wireless device. For example, a courier delivery person could request the location of a package recipient's cellular telephone or pager and, under the FCC requirement, still be over the length of a football field away from the recipient (presuming the recipient is collocated with his or her cellular phone) when the delivery person arrives. If other cellular telephone users are also in the area, the delivery person may never be able to personally contact the intended package recipient.

Therefore, a need exists for a method and apparatus for accurately locating a communication device (and therefore the user of the communication device) in a wireless communication system that both provides a highly accurate location of the device and is inexpensive to implement.

### BRIEF DESCRIPTION OF THE DRAWINGS

FIG. 1 is a block diagram of an exemplary wireless communication system that operates in accordance with the present invention.

FIG. 2 is a block diagram of a communication device in accordance with a preferred embodiment of the present invention.

FIG. 3 is an exemplary map displayed on the display of the communication device of FIG. 2 corresponding to an approximate location of the communication device.

FIG. 4 is an exemplary higher resolution map displayed on the display of the communication device of FIG. 2 corresponding to a more accurate location of the communication device.

FIGS. 5A and 5B are a logic flow diagram of steps executed by a system infrastructure of a wireless communication system to accurately locate a communication device in accordance with a preferred embodiment of the present invention.

FIG. 6 is a logic flow diagram of steps executed by a system infrastructure of a wireless communication system to accurately locate a communication device in accordance with an alternative embodiment of the present invention.

FIG. 7 is a logic flow diagram of steps executed by a communication device to assist a system infrastructure of a wireless communication system in accurately locating the communication device in accordance with a preferred embodiment of the present invention.

FIG. 8 is a logic flow diagram of steps executed by a communication device to assist a system infrastructure of a wireless communication system in accurately locating the communication device in accordance with an alternative embodiment of the present invention.

FIG. 9 is a logic flow diagram of steps executed by a communication device to assist a system infrastructure of a wireless communication system in accurately locating the communication device in accordance with yet another embodiment of the present invention.

### DETAILED DESCRIPTION OF A PREFERRED EMBODIMENT

Generally, the present invention encompasses a method and apparatus for accurately locating a communication device in a wireless communication system. The communication system includes a system infrastructure that provides communication services to communication devices distributed throughout the communication system. Either on its own or, more preferably, responsive to a request for an accurate location of a particular communication device from a requesting device, the system infrastructure determines an approximate geographic location of the communication device. Based on the approximate location, the system infrastructure transmits a request to the communication device for a more accurate geographic location of the device preferably together with a map of an area that includes the approximate geographic location of the device. The communication device preferably displays at least the map to a user of the device and, responsive to user input, transmits the more accurate geographic location of the device to the system infrastructure, preferably in the form of a modified representation of the originally received map indicating the more accurate location of the communication device. After receiving the more accurate location from the communication device, the system infrastructure conveys the location to a target device preferably identified in the original location request received by the system infrastructure.

By accurately locating a communication device in this manner, the present invention enables a communication device, and typically its user, to be precisely located by the system infrastructure in the event of an emergency or in the event that a requester of the device's location desires to meet personally with the user of the located device. Because the location of the device is determined by the device itself, and more particularly the user of the device, the location of the device can be determined accurately both horizontally and vertically, regardless of the device's location. By contrast, although prior art systems that incorporate GPS receivers in the communication devices can determine mobile device location fairly accurately horizontally (e.g., within ten meters), they are much less accurate in locating the device vertically and/or when the device is inside a building or in any other area having obscured access to the orbiting global positioning satellites. In addition, although GPS technology is relatively accurate, the inclusion of such technology in mobile communication devices can increase the cost of such devices substantially as compared to the cost of such devices without GPS technology. The present invention can be implemented by modifying the software in the communication devices and system infrastructure, thereby adding very little cost, if any, to the overall manufacturing and sales prices of the communication devices.

The present invention can be more fully understood with reference to FIGS. 1-9, in which like reference numerals designate like items. FIG. 1 illustrates a block diagram of an exemplary wireless communication system 100 in accordance with the present invention. The communication system 100 includes one or more wireless communication devices 101, 102 (two shown) and a system infrastructure. The system infrastructure includes, inter alia, one or more base transceiver sites 104, 105 (two shown), a wireless system controller 107, a map database 109, and communication links 114, 116 coupling the system controller 107 to the base transceiver sites 104, 105.

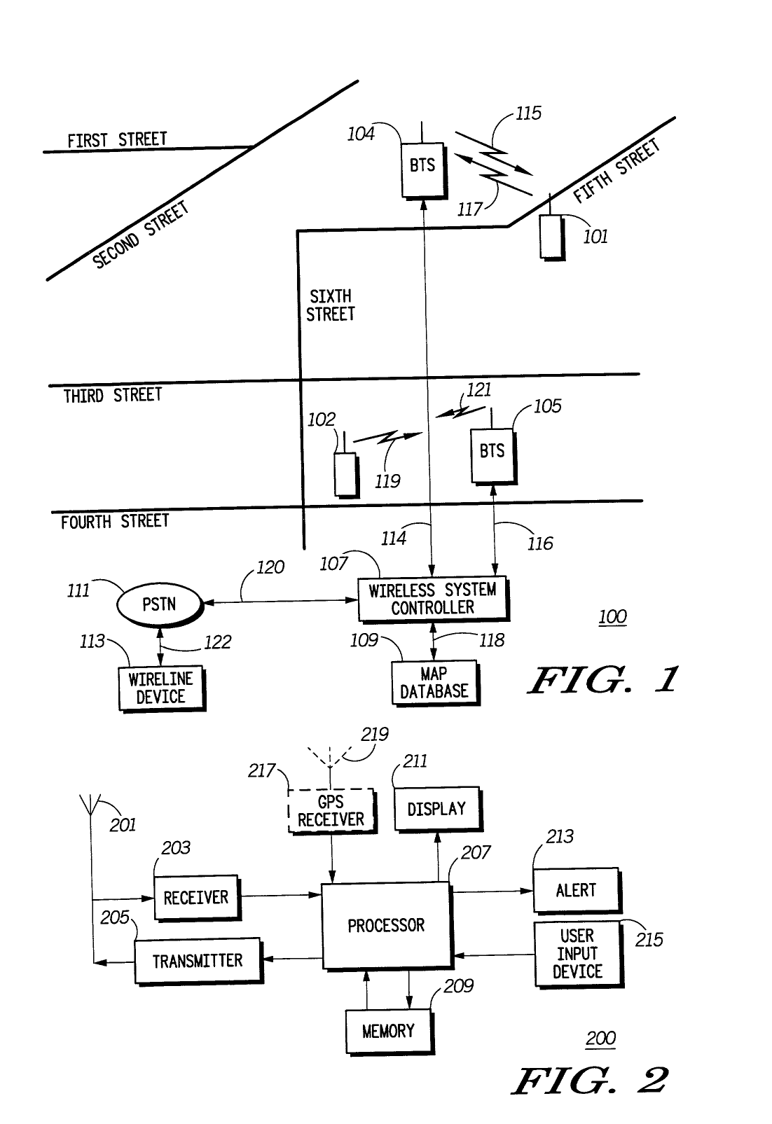

The communication system 100 might comprise a two-way radio system, a cellular telephone system, a cordless telephone system (e.g., a wireless local loop), a home wireless network, a personal communication system (PCS), a personal area network (e.g., a Bluetooth network), a wireless data system, a paging system, or any combination thereof. Accordingly, the communication devices 101, 102 may comprise two-way mobile or portable radios, radiotelephones, two-way pagers, wireless data terminals, or any combination thereof. A preferred communication device 200 is described in detail below with respect to FIG. 2.

Depending on the type of system 100, each base transceiver site (BTS) 104, 105 may comprise transmitters, receivers, control and storage equipment, and telephone interconnect equipment. The wireless system controller 107 comprises any known controller, such as a base site controller, a paging system controller, a central controller, or a dispatch application processor, appropriate for controlling communications in the particular system 100.

Except for appropriate software modifications necessary to implement the present invention as described below, the components of each BTS 104, 105 and of the wireless system controller 107 are well known; thus no further discussion of them will be presented except to facilitate an understanding of the present invention.

The communication links 114, 116 may comprise any known communication links, including, but not limited to, leased telephone lines, such as T1 or T3 lines, microwave links, integrated services digital network (ISDN) lines, digital subscriber lines (DSLs), low speed (e.g., 56 kilobit per second) data links, RS-232 links, or a common hardware bus when the BTSs 104, 105 are directly coupled to system controller 107. In the event that the BTSs 104, 105 are not so directly coupled to system controller 107, the communication links 114, 116 may include other elements, such as switches or switching centers, routers, gateways, bridges, controllers, or any other components used to interconnect systems or portions thereof. The map database 109 preferably comprises a detailed map of the system 100 in electronic form, portions of which are preferably provided to the communication devices 101, 102 in accordance with the operation of the present invention. The map database 109 may be external to the wireless system controller 107 (as shown) or may reside within the wireless system controller 107. When located external to the system controller 107, the map database 109 is coupled to the system controller 107 via an appropriate communication link 118, such as an RS-232 link, an Ethernet link, an Internet connection, a common hardware bus, or any conventional means for interconnecting a wide area network (WAN) or a local area network (LAN).

Each BTS 104, 105 provides communication service to a respective service coverage area, conveying information to and receiving information from communication devices 101, 102 located in the service coverage area over wireless communication resources. Depending on the access scheme utilized in the system 100, each communication resource may comprise a frequency carrier, one or more time slots of a frequency carrier, or an orthogonal code implemented by a respective frequency hopping pattern or by a pseudo-random noise sequence spread over a wide (e.g., 3 MHz) bandwidth.

In the event that the wireless system 100 is configured to permit communication with wireline communication devices 113, such as telephones, computers, data terminals, personal digital assistants, Internet servers, and other such devices, connected to the public switched telephone network (PSTN) or other service provider 111, the wireless system controller 107 is coupled to the PSTN/Service Provider 111 via an appropriate communication link 120, such as an ordinary telephone line, a T1 or T3 leased line, an ISDN line, a DSL link, a low speed data link, or any other voice or data link.

FIG. 2 is a block diagram of a communication device 200 in accordance with a preferred embodiment of the present invention. The communication device 200 includes a receiver antenna 201, a receiver 203, a transmitter 205, a processor 207, a memory 209, a display 211, an alerting device 213, and a user input device 215. The communication device 200 may optionally include a GPS receiver 217 and an associated antenna 219, although the inclusion of such a receiver 217 and antenna 219 is not preferred due to the costs associated with their inclusion.

The receiver antenna 201 is a conventional antenna capable of receiving signals transmitted from a BTS 104, 105. The receiver 203 is a conventional receiver for receiving a signal in accordance with the system's communication protocol and for decoding the received information to provide decoded information to the processor 207. The receiver 203 includes well-known components, such as filters, mixers, small-signal amplifiers, a demodulator, and other known elements necessary to receive, demodulate, and decode signals in accordance with the communication protocol utilized in the system 100. The transmitter 302 is also well-known and includes filters, mixers, a modulator, large-signal amplifiers, and other known elements to produce a radio frequency or microwave signal bearing information to be conveyed to the system infrastructure and/or to one or more communication devices 101, 102, 113 over a wireless resource or channel.

The processor 207 comprises one or more microprocessors and/or one or more digital signal processors. The memory 209 is coupled to the processor 207 and preferably comprises a read-only memory (ROM), a random-access memory (RAM), a programmable ROM (PROM), and/or an electrically erasable read-only memory (EEPROM). The memory 209 preferably includes multiple memory locations for storing, inter alia, the computer programs executed by the processor 209, the address or addresses assigned to the communication device 200, information received from the BTSs 104, 105 for later retrieval by a user of the communication device 200, and a map of an area that includes an approximate location of the communication device 200 either received from the system infrastructure or stored in the communication device 200 during fabrication of the device 200. The computer programs are preferably stored in ROM or PROM and direct the processor 207 in controlling the operation of the communication device 200. The address or addresses of the communication device 200 are preferably stored in EEPROM. The information received from the base transceiver sites 101, 102, including the map, is preferably stored in RAM. In the event that the map is stored in the communication device 200 at the factory, the map may be stored in ROM or EEPROM.

The processor 207 is preferably programmed to alert the user of the communication device 200 of the device's receipt and storage of information, such as a request for the device's location, by way of the alerting device 213. The alerting device 213 preferably uses a conventional vibration or audible alerting mechanism. Once the user has been alerted, the user can invoke functions accessible through the user input device 215 to perceive the stored information and respond to it as necessary. The user input device 215 preferably comprises one or more of various known input devices, such as a keypad, a computer mouse, a touchpad, a touchscreen, a trackball, and a keyboard.

Either responsive to signaling from the user input device 215 or automatically upon receipt of certain information from the receiver 203, the processor 207 directs the stored information or received information, as applicable, to the display 211. The display 211 presents the selected information to the user by way of a conventional liquid crystal display (LCD) or other visual display, or alternatively by way of a conventional audible device for playing out audible messages. In addition, the processor 207 may instruct the display 211 to automatically present the user of the communication device 200 with at least a visual indication (e.g., an icon or an icon in combination with a periodic chime) that informs the user that newly received information is stored in the memory device 209. The communication device 200 of FIG. 2 is preferably used to implement all of the wireless communication devices 101, 102 in the system 100.

A communication device (e.g., device 101) is accurately located in the exemplary communication system 100 of FIG. 1 substantially as follows in accordance with the present invention. In the event that a requesting device, such as wireline device 113, wireless device 102, or even the communication device 101 itself (e.g., when the user of device 101 desires to inform another person of his or her location), desires to accurately locate the communication device 101 in the wireless system 100, the requesting device sends a request for the location of the communication device 101 to the wireless system controller 107. The request preferably includes the identification (ID) or address of the communication device 101 to be located and the address or ID of a target device (which may by the same device as the requesting device) to which the location is to be sent.

For example, a courier service employee who has a package to deliver to the user of communication device 101 may dial the access number of the wireless system 100 from his or her wireline phone 113 or cellular phone 102. In the event that the employee uses a wireline device 113, the signal carrying the access number arrives at the wireless system controller 107 via the PSTN 111 and communication link 120. In the event that the employee uses a wireless device 102, the signal 119 bearing the access number arrives at the wireless system controller 107 via BTS 105 and communication link 116. In either event, the wireless system controller 107 preferably responds with a list of options, one of which is locating a particular communication device.

When the employee selects the device location option, the system controller 107 requests the ID, address, or other identifying information of the communication device 101 to be located (e.g., telephone number or pager number) and the ID, address, or other identifying information (e.g., telephone number) of the target device to which the location of the communication device 101 is to be sent if such device is different than the requesting device. In most cases, the target device is equivalent to the requesting device, except when the communication device 101 is requesting the determination of its own location for transmission to another. The employee then inputs the appropriate information to complete the location request. When the requesting device is the communication device 101 itself or another wireless device 102, the device 101, 102 may include a function that permits the device user to simply input the ID, address, or other identifying information of the communication device 101 to be located and automatically transmits a location request to the system infrastructure without requiring the requesting device user to step through the sequence of options described above. Further, when the requesting device is a wireline computer accessing the Internet, the information required to create the location request may be entered by the computer user into a form page and transmitted simultaneously to the system controller 107 via the Internet Service Provider 111.

Responsive to receiving the completed location request, the system infrastructure determines an approximate geographic location of the communication device 101 using any known technique. For example, in a cellular system or other frequency reuse system, the system controller 107 may determine the communication device's approximate location as the cell or coverage area serviced by the BTS 104 that last received a transmission from the device 101. Alternatively, the system infrastructure may employ known infrastructure-only or communication device-assisted triangulation techniques to approximately locate the device 101. Still further, in systems in which the communication device 101 includes a GPS receiver 217 or otherwise automatically determines its own location (e.g., using triangulation techniques and referring to a database of known BTS locations), the system infrastructure may transmit a request to the communication device 101 for its approximate location and receive such location from the device 101 responsive to the request.

Having approximately or coarsely located the communication device 101, the system controller 107 determines the BTS 104 serving the coverage area containing the communication device 101 and transmits a signal 115 bearing at least a request for a more accurate location of the communication device 101 to the communication device 101 via the determined BTS 104. For example, if the communication device 101 was coarsely located as being in the coverage area of BTS 104, then the system controller 107 transmits the request and any other information, such as a map as explained below, via BTS 104. Alternatively, if the approximate location of the communication device 101 was determined using triangulation or GPS techniques, then the system infrastructure 107 consults a database (not shown) to determine which BTS serves the coverage area containing the device's approximate location and transmits the request and any other information via the determined BTS.

In the event that the transmitted signal 115 includes only a request, the request may be a digitally-encoded alpha-numeric message, such as “Where are you located?”. In a preferred embodiment, the signal 115 bearing the request also bears data representing a map of an area that includes the approximate location of the communication device 101. The system controller 107 retrieves the data representing the map from the map database 109 based on the approximate location of the communication device 101. The resolution of the retrieved map is determined based on the technique used to determine the device's approximate location. For example, if the approximate location of the communication device 101 was determined as being the entire coverage area of BTS 104, then a map containing the entire coverage area (e.g., a square mile) of BTS 104 would be retrieved from the map database 109. If, on the other hand, the approximate location of the communication device 101 was determined more accurately using triangulation or GPS techniques, then a higher resolution map (e.g., a map encompassing one-fourth of a square mile) may be retrieved from the database 109. Once the appropriate map data has been retrieved, the system controller 107 conveys the map data to the communication device 101 preferably together with the request for a more accurate location of the communication device 101.

The signal 115 bearing the request for a more accurate location and/or the map are received by the communication device's antenna 201, processed by the device's receiver 203 in accordance with known techniques, and provided to the processor 207. The processor 207 analyzes the received data and, upon determining that the data includes the request for a more accurate location and/or a map, stores the request and/or map data in temporary memory 209 (e.g., RAM) and instructs the display 211 to display the request and/or the map to the user of the device 101. The processor 207 may additionally instruct the alerting device 213 to alert the user (e.g., through the use of vibrations or an audible series of beeps) that the request and/or map have arrived.

When both a request for a more accurate location and a map have been received, the processor 207 may instruct the display 211 to display both the request (e.g., “Please indicate your location on the map” or “Indicate Location”) and the map or the map only (with the presumption that when the user sees the map he or she understands that the map represents a request for a more accurate location of the communication device 101). When only a map has been received, the processor 207 treats the map as an implied request for a more accurate location and instructs the display 211 to display the map and optionally a canned textual request message previously stored in the device's memory 209 to the user. Lastly, when only a request for a more accurate location has been received, the processor 207 instructs the display 211 to display the request to the user.

In an alternative embodiment in which the communication device 101 does not possess graphics capabilities or possesses very limited graphics capabilities, the request for a more accurate location may be accompanied by a textual description of an area that includes the approximate location of the communication device 101 as presently understood by the system controller 107. The textual description may then be used as a format with which the device user can respond with the more accurate location as described below. For the purposes of the following discussion, it is assumed that both a request for a more accurate location and a map have been conveyed to and received by the communication device 101, but that only the map is being displayed to the user.

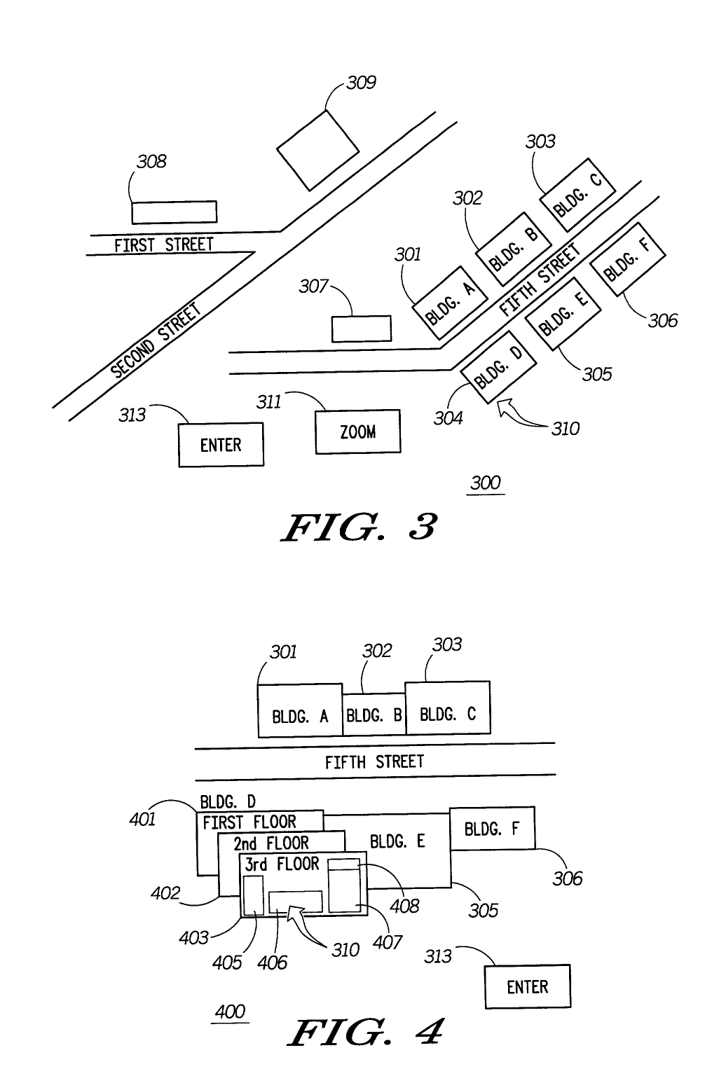

An exemplary map 300 that may be displayed to the user of the communication device 101 based on the device's approximate location on Fifth Street is illustrated in FIG. 3. As shown, the map 300 preferably depicts the geographic area surrounding the device's approximate location as determined by the system controller 107 and may include streets and street names (e.g., “First Street”, “Second Street”, and “Fifth Street”), and buildings 301-309 and building names, if applicable (e.g., “Bldg. A” and so forth). The map 300 may also include a virtual “Zoom” button 311 to enable the user to request a higher resolution map on which to indicate his or her, and the device's, location. An exemplary higher resolution map 400 is illustrated in FIG. 4. For the purposes of this discussion, it is assumed that the communication device 101 is located in an office on the third floor of building 304.

Upon viewing map 300, the user may determine that the resolution of map 300 is not detailed enough to accurately indicate the device's location. Accordingly, the user may then select an area on the map 300 by moving a cursor 310 or some other indicator to a more accurate, but still approximate, location of the device 101 using the user input device 215, selecting the new location using the user input device 215 (e.g., by depressing or clicking a left mouse button or depressing an enter key), and then moving the cursor 310 or other indicator onto a portion of the “Zoom” button 311 and selecting the “Zoom” button 311 (e.g., by depressing or clicking a left mouse button or depressing an enter key). Upon receiving the zoom request from the user input device 215, the processor 207 constructs a message containing information identifying the new approximate location of the communication device 101 on the map 300 and a request for a new, higher resolution map 400 that includes the identified new location of the communication device 101. The processor 207 then forwards the message to the transmitter 205 for transmission of a signal 117 bearing the message to the system infrastructure in accordance with known techniques.

After receiving the request for a higher resolution map, the system controller 107 retrieves the new map from the map database 109 and transmits a signal 115 bearing the map to the communication device 101 via BTS 104. Upon receiving the new map, the device processor 207 stores the map data in temporary memory 209 (e.g., RAM) and instructs the display 211 to display the map 400 to the user. As depicted in FIG. 4, the new map 400 may be limited to a small section of a street, a building 304, or the floor or floors 401-403 of a building 304. In addition, the processor 207 may initially instruct the display 211 to display only the building and street outlines on the higher resolution map 400. In this case, if the user desires to view the floor details of a particular building 304 in an attempt to accurately identify the device's vertical location or height, the user preferably moves the cursor 310 or other indicator onto the building 304 and selects the building 304 (e.g., by double-clicking a mouse button or depressing a function key on the keypad). Responsive to the selection, the processor 207 retrieves additional details (e.g., number of floors 401-403) from memory 209 and instructs the display 211 to display them. If the device user wants more detail with respect to a floor 403 of the building 304, the user may move the cursor 310 onto a portion of the particular floor representation and select the floor 403 (e.g., by double-clicking a mouse button or depressing a function key on the keypad). Responsive to this selection, the processor 207 retrieves additional details (e.g., the layout of offices on the floor 403) from memory 209 and instructs the display 211 to display them.

Once sufficient detail is displayed to the user to allow the user to accurately indicate the device's location, the user uses the user input device 215 to indicate the device's location on the currently-displayed map. For example, if the resolution of map 300 is sufficient to accurately indicate the device's location (e.g., because the device and the user are located on the sidewalk directly in front of building 304), the user uses the user input device 215 to indicate the device's location on map 300. By contrast, if higher resolution is necessary, the user uses the user input device 215 to indicate the device's location on a higher resolution map 400. To indicate location, the user may position the cursor 310 or other indicator on the map 300, 400 at the location of the device and select the location using the user input device 215 (e.g., by clicking a mouse button, depressing a function key, or depressing an enter key). If the user clicked a mouse button to identify the location, the user may also need to select a virtual “Enter” button 313 or depress an enter key on the keyboard or keypad to confirm the selection.

In an alternative embodiment, instead of sending the map together with the request for a more accurate location, the system controller 107 and the communication device 101 may be programmed to periodically provide and maintain a current map of the device's approximate location. In this embodiment, the system controller 207 periodically determines the approximate location of the communication device 101 using any one or more of the aforementioned known location techniques. When the most recent location of the device 101 is sufficiently different than a previous location, the system controller 107 automatically retrieves a new map from the map database 109 and transmits it to the communication device 101. The communication device 101 stores the most recent map in its memory 209. Since the communication device 101 already has the map, the system controller 107 need only send a request for a more accurate location when such a more accurate location is desired by a requesting device or the system controller 107 itself. Upon receiving the request, the communication device 101 automatically retrieves the stored map from memory 209 and displays it to the user as described above.

In addition to indicating the location of the device 101 on the map 300, 400, the user may also add textual or graphical information to further identify the device's location or communicate with a user of the target device. For example, the user may add written instructions to the device's location from some reference point (e.g., the intersection of “Third Street” and “Sixth Street”) or may include directional arrows to guide the user of the target device to the correct location. The user may additionally or alternatively include a textual message, such as “Meet me at 9:00”, directed to the user of the target device. Moreover, in the event that the communication device 101 does not have graphical capabilities, the user of the communication device 101 may respond to the request for a more accurate location by entering an accurate textual description of the location of the device 101.

Once the user has selected and/or described the device's accurate location, the processor 207 prepares a message that includes the device's location. In the preferred embodiment, the processor 207 creates a data message that corresponds to a modified representation of the map 300, 400 on which the user indicated the device's location. The modified representation of the map 300, 400 preferably includes an indicator, such as an arrow, a star, an icon, or any other graphical element, identifying the location of the device 101 on the map 300, 400. In the event that the user has entered additional textual or graphical information to further assist in locating the device 101 or to communicate with a user of the target device, the message created by the processor 207 includes the additional information. Still further, in the event that the communication device 101 does not include graphical capabilities, the data message includes the textual description of the device's location as entered by the device's user.

Having prepared the message, the processor 207 forwards the message to the transmitter 205 for conversion into a modulated signal 117 and transmission to the system controller 107 via BTS 104. Upon receiving the message, the system controller 107 identifies the target device (i.e., the device to which the accurate location of communication device 101 is to be provided) and conveys information identifying the accurate location of the communication device 101 to the target device. As noted above, the target device is preferably identified in the request received by the system controller 107 for a location of the communication device 101. The target device may be the requesting device (e.g., when the user of the requesting device 102, 113 desires to meet personally with the user of the communication device 101) or some other device (e.g., when the user of the communication device 101 unilaterally desires to inform the user of the other device of his or her location). In the event that the target device is a wireless communication device 102, the system controller 107 conveys the location of device 101 to the target device 102 via a signal 121 transmitted from the BTS 105 serving the coverage area containing the target device 102. In the event that the target device is a wireline device 113, the system controller 107 conveys the location of device 101 to the target device 113 via the PSTN/Service Provider 111 or any other wide area network, such as the Internet.

The information conveyed to the target device to identify the location of communication device 101 depends upon the functional capabilities of the target device. For example, in the event that the target device has graphical capabilities, the information conveyed to the target device preferably comprises a map indicating the location of the communication device 101. That is, in the preferred embodiment, the map transmitted from the communication device 101 to the system infrastructure, or some variant thereof, is forwarded together with any accompanying textual or other graphical information to the target device to enable the user of the target device to view, in representative form, the location of the device 101. In the event that the target device does not have graphical capabilities or has limited graphical capabilities that are not sufficient enough for displaying a map (e.g., the target device is a two-way alpha-numeric pager), the system controller 107 conveys a textual description of the location of the device 101 together with any other accompanying textual information or messaging to the target device. Having received the location of the communication device 101 and any other information, the user of the target device (e.g., the courier service employee in the above example) can now accurately locate the user of the communication device 101 as necessary (e.g., for a personal meeting).

In an alternative embodiment, the system controller 107 may automatically determine a location of the target device and generate its own supplemental information related to the locations of both the communication device 101 and the target device to convey to the target device along with the location of the communication device 101. For example, the system controller 107 may determine the location of the target device using any one or more of the above-described location techniques (e.g., when the target device is a wireless device 102) or using information provisioned in the wireline system or received from a user of the target device (e.g., when the target device is a wireline device 113). Having determined the target device's location, the system controller 107 may then convey information to the target device related to the locations of the communication device 101 and the target device, such as directions from the location of the target device to the location of the communication device 101, an approximate distance between the two locations, and/or an approximate commute time between the two locations. Alternatively, in the event that the communication device 101 is located a substantial distance away from the target device, the system controller 107 may inform the target device of the city, state, and/or country in which the communication device 101 is presently located.

As described above, the present invention enables persons to accurately locate other persons that use wireless communication devices. In contrast to prior art approaches that automatically determine approximate locations of wireless communication devices with limited accuracy, especially within buildings and vertically, the present invention provides for the interaction of the wireless device user to enable a very precise location determination because the device user truly knows where the device is located. In addition, the present invention, unlike prior art automated approaches, provides for the use of a map as the preferred interface for the user of the wireless device being located to indicate the device's location. Further, the present invention also utilizes a map as the preferred interface for the user of the target device desiring to locate the wireless device to view the representative location of the wireless device. The use of such maps enables both users to easily relate the location of the wireless device to the locations of other known structures. Still further, the present invention provides for accurate locating of wireless devices in a very cost-effective manner, requiring modifications primarily to the software of the wireless devices and the system infrastructure, in sharp contrast to the costly hardware and other modifications necessary to incorporate GPS technology in wireless communication devices.

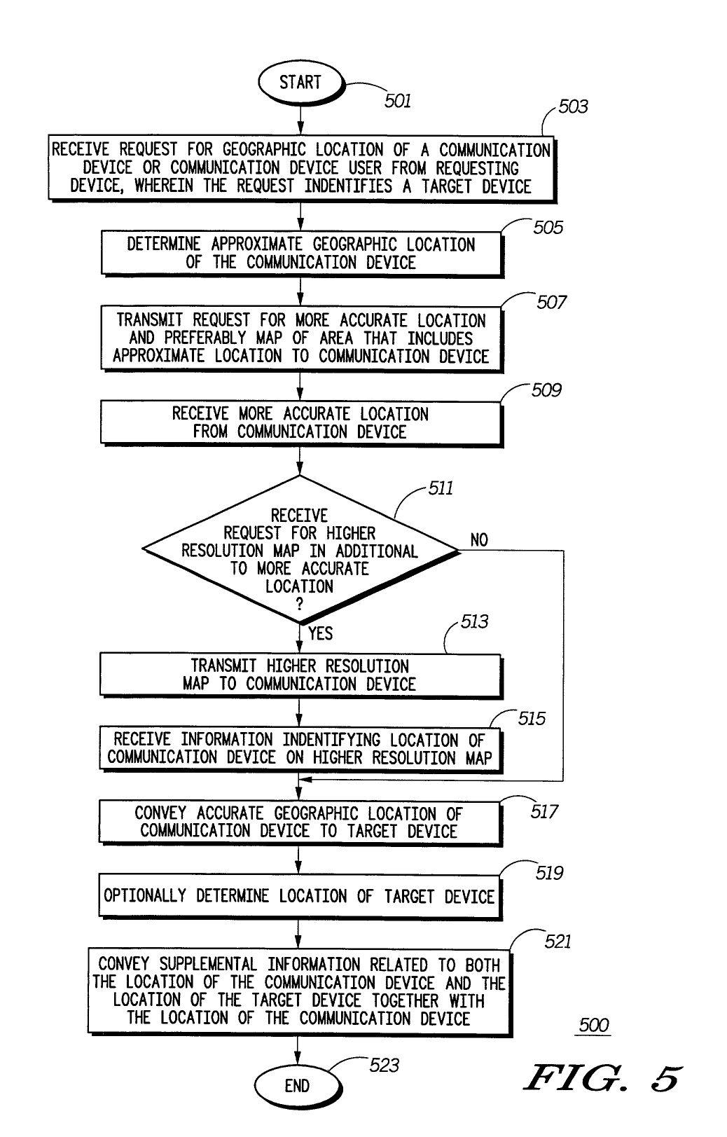

FIGS. 5A and 5B are a logic flow diagram 500 of steps executed by a system infrastructure of a wireless communication system to accurately locate a communication device in accordance with a preferred embodiment of the present invention. The logic flow begins (501) when the system infrastructure receives (503) a request for a geographic location of a communication device or a communication device user from a requesting device, wherein the request identifies a target device to receive the requested location. As described above, the requesting device may be the target device or the communication device itself (e.g., when the user of the communication device desires to provide the device's location to a user of another device). The request message may be received as a single data message from a wireless or wireline requesting device having the capability to generate such a message, such as a data-compatible radio or a computer, or as a collection of responses (e.g., touch tone responses) to voice prompts from the system infrastructure.

Having received the location request, the system infrastructure determines (505) an approximate or coarse location of the communication device in accordance with known techniques and transmits (507) at least a request to the communication device for a more accurate location of the communication device. In the preferred embodiment, the system infrastructure also transmits (507) a map of an area that includes the approximate location of the communication device determined pursuant to block 505. The resolution of the transmitted map is based on the technique or techniques used to determine the device's approximate location. The more accurate the locating technique or techniques, the higher the possible resolution of the map.

Some time after transmitting the request for a more accurate location and/or the map, the system infrastructure receives (509) the more accurate location of the communication device from the communication device. In the preferred embodiment, the more accurate location comprises information identifying a location of the communication device on the map, such as a modified representation of the map indicating the location of the device as the representative location of an indicator, such as an arrow, an icon, or a star, on the map. The more accurate location may also include textual information (e.g., directions to the device's location from a reference point) and/or other graphical information (e.g., directional arrows depicting how to get to the device's location from a reference point) further identifying the location of the communication device.

Upon receiving the more accurate location from the communication device, the system infrastructure determines (511) whether it received a request (e.g., a zoom request) from the communication device for a higher resolution map in addition to the more accurate location. In the event that the system infrastructure received such a request, the system infrastructure transmits (513) a higher resolution map to the communication device depicting an area that includes the more accurate location of the communication device received pursuant to block 509. It will be appreciated that the reception (511) of a zoom request and transmission (513) of a higher resolution map responsive thereto may be repeated multiple times at the option of the communication device user. That is, in the event that the transmitted higher resolution map is not of a high enough resolution for the device user to accurately indicate the device's location, the user may transmit another zoom request, which request would then be received (511) and responded to in the form of another higher resolution map transmitted (513) by the system infrastructure.

Some time after transmitting a higher resolution map, the system infrastructure receives (515) information identifying the location of the communication device on the higher resolution map. Such information preferably comprises a modified representation of the higher resolution map indicating the location of the device as the representative location of an indicator, such as an arrow, an icon, or a star, on the map. The identifying information may also include textual information and/or other graphical information further identifying the location of the communication device.

Upon receiving the accurate location of the communication device either responsive to transmission of the request and the low resolution map, if so transmitted, or responsive to transmission of a higher resolution map, the system infrastructure conveys (517) the accurate geographic location of the communication device to the target device. The form of the location information conveyed to the target device depends on the capabilities of the target device and/or the format of the information requested by the requesting device. For example, if the target device is not graphics-capable or has limited graphics capability or the requesting device requested a textual description in its original request for the device's location, the location of the communication device may be described in text (e.g., “in the office of J. Doe on the third floor of Building D”). Alternatively and more preferably, if the target device is graphics-capable, a map is conveyed to the target device indicating the location of the communication device on the map. Other textual or graphical information, such as directions or directional arrows, may also be conveyed to the target device to further identify the location of the communication device if such additional information was provided to the system infrastructure by the communication device.

In addition to conveying the accurate location of the communication device to the target device, the system infrastructure may optionally determine (519) the location of the target device in accordance with known techniques or based on the provision of such location by the requesting device and convey (521) supplemental information to the target device based on the locations of both the communication device and the target device. As described above, the supplemental information may comprise directions from the location of the target device to the location of the communication device, an approximate distance between the two locations, and/or an approximate commute time between the two locations. Alternatively, depending on the distance between the communication device and the target device, the supplemental information may comprise the city, state, and/or country where the communication device is presently located in the event that that distance between the target device and communication device is substantial (e.g., greater than a predetermined threshold, such as fifty miles or eighty kilometers). After the accurate location of the communication device and the supplemental information, if optionally generated, have been conveyed to the target device, the logic flow ends (523).

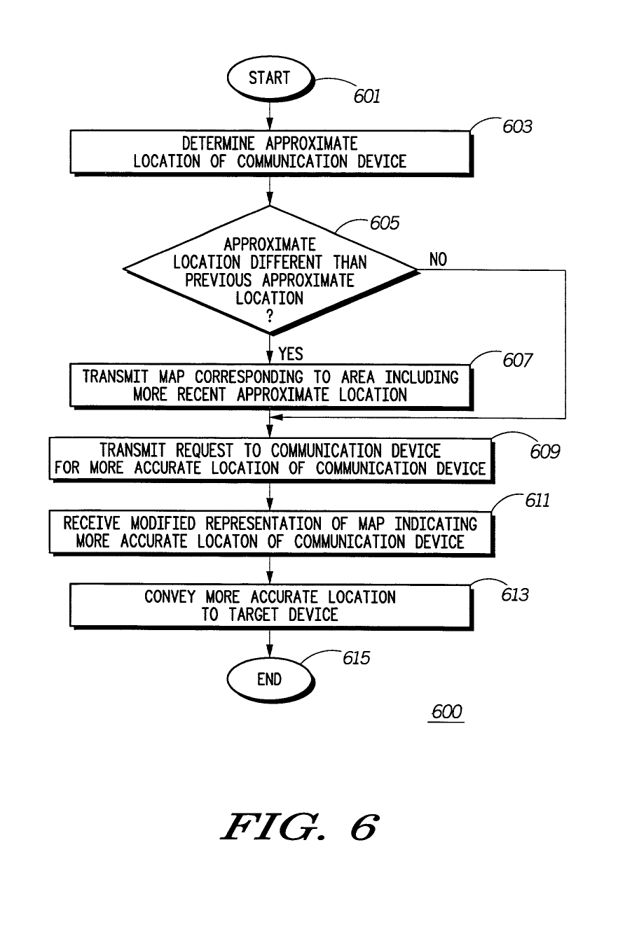

FIG. 6 is a logic flow diagram 600 of steps executed by a system infrastructure of a wireless communication system to accurately locate a communication device in accordance with an alternative embodiment of the present invention. The logic flow begins (601) when the system infrastructure determines (603) an approximate location of the communication device in accordance with known techniques. The determination of block 603 is preferably self-generated by the system infrastructure in anticipation of a request for the device's location and may be performed periodically (e.g., once every one-half hour). After determining the communication device's approximate location, the system infrastructure determines (605) whether the approximate location of the communication device determined pursuant to block 603 is different than a previously-determined approximate location. In the event that the current approximate location is sufficiently different from the previous approximate location to warrant the conveyance of a new map (e.g., the two locations are greater than one hundred meters apart), the system infrastructure automatically transmits (607) a map to the communication device corresponding to the area including the more recent approximate location. Therefore, in this embodiment, the system infrastructure attempts to automatically provide the communication device with an up-to-date map in anticipation of a request from some other device for an accurate location of the communication device. Accordingly, the system infrastructure in this embodiment preferably periodically determines the communication device's approximate location and updates the communication device's stored map as necessary based on the determined locations.

Some time after the system infrastructure determines that the communication device does not need a new map (i.e., the communication device's approximate location has not changed appreciably) or has conveyed an updated map to the communication device, the system infrastructure transmits (609) a request to the communication device for a more accurate location of the communication device. The request may be self-generated by the system infrastructure or, more preferably, is responsive to a request received from another device for an accurate location of the communication device. Responsive to the request, the system infrastructure receives (611) from the communication device a modified representation of a map (either the map transmitted to the communication device pursuant to block 607 or another map previously transmitted to the communication device) indicating the more accurate location of the communication device. The modified representation of the map preferably includes an indicator, such as an arrow or an icon, positioned at the representative location of the communication device on the map. In addition to the modified representation of the map, the system infrastructure may receive other textual or graphical information from the communication device further identifying the location of the communication device.

After receiving the location of the communication device in the form of a modified representation of a map and any other information from the communication device, the system infrastructure conveys (613) the accurate location of the communication device and the other information, if any, to a target device and the logic flow ends (615). The target device preferably comprises a wireline or wireless device that requested the communication device's location from the system infrastructure. Alternatively, the target device comprises a wireline or wireless device identified by the communication device itself. As described above, the accurate location of the communication device conveyed to the target device preferably comprises a map that includes an indicator positioned at the representative location of the communication device on the map. Alternatively, the accurate location of the communication device may be a textual or synthesized audio description of the communication device's location.

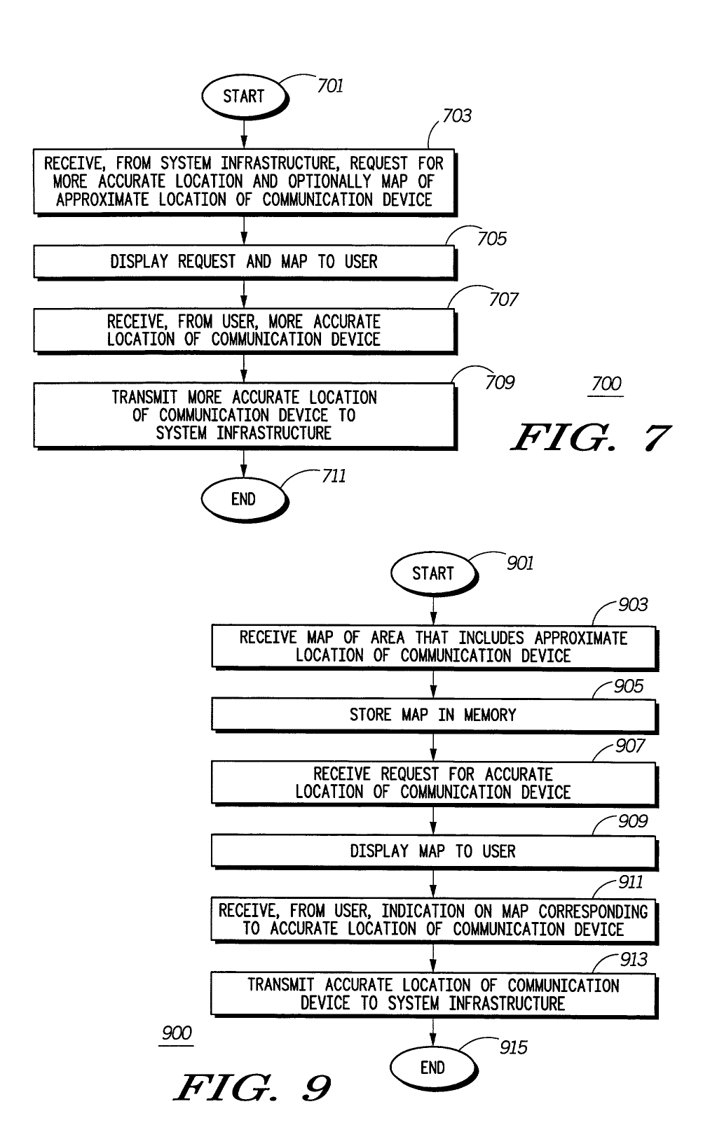

FIG. 7 is a logic flow diagram 700 of steps executed by a communication device to assist a system infrastructure of a wireless communication system in accurately locating the communication device in accordance with a preferred embodiment of the present invention. The logic flow begins (701) when the communication device receives (703), from the system infrastructure, a request for a more accurate location of the communication device and optionally a map of an area that includes an approximate location of the communication device. The communication device displays (705) the request (e.g., “Please provide your location on the map”) and the map, if so received, to the user of the device.

Some time after displaying the map and the request, the communication device receives (707), from the user of the device, the requested accurate geographic location of the communication device. The location is preferably indicated on the displayed map, but may otherwise be identified by a textual description. When the communication device is located above the ground (e.g., in an upper floor of a high rise building), the location received from the user preferably includes information indicating a height or vertical position of the communication device. Upon receiving the accurate location of the communication device from the user, the communication device transmits (709) the location to the system infrastructure, preferably for subsequent delivery to a target wireline or wireless device, and the logic flow ends (711).

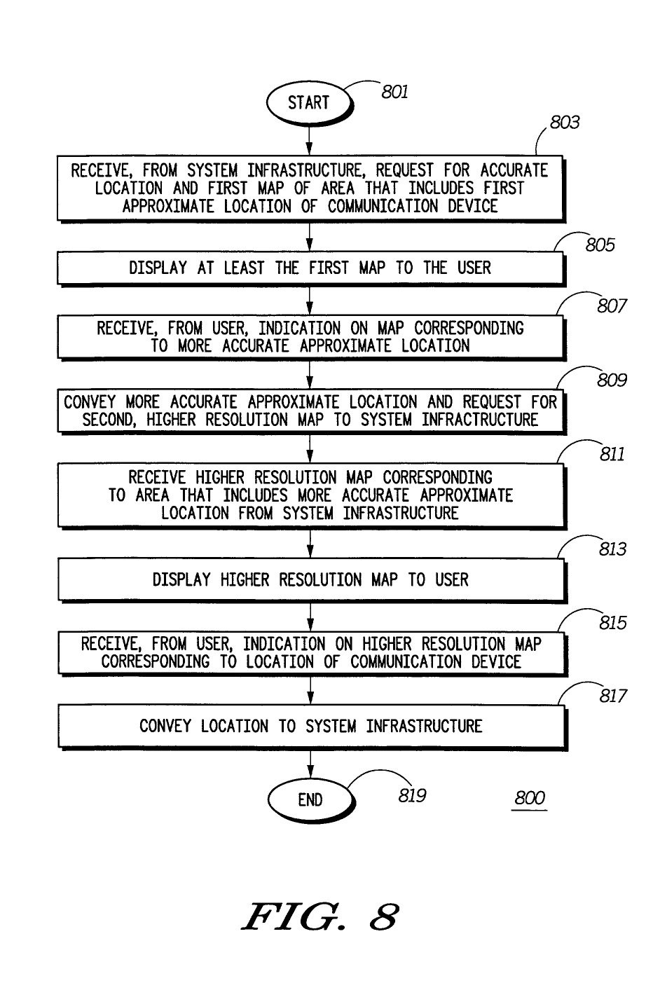

FIG. 8 is a logic flow diagram 800 of steps executed by a communication device to assist a system infrastructure of a wireless communication system in accurately locating the communication device in accordance with an alternative embodiment of the present invention. The logic flow begins (801) when the communication device receives (803), from the system infrastructure, a request for an accurate location of the communication device and a map of an area that includes an approximate location of the communication device. The communication device displays (805) at least the map, and preferably the request, to the user of the communication device.

Some time after displaying the map, the communication device receives (807), from the device user, an indication on the map corresponding to a more accurate, but still approximate, location of the communication device and preferably a request for a higher resolution map. For example, upon viewing the map displayed pursuant to block 805, the user may determine that the map is not of a high enough resolution to permit the user to accurately indicate the device's (and the user's) location. Consequently, the user indicates the device's approximate location on the map (e.g., by moving a cursor or other indicator to the representative approximate location on the map and clicking a mouse button or depressing an enter key on the device's keypad) and requests a higher resolution map that includes the new approximate location (e.g., by selecting a virtual zoom button displayed on the device's display).

After receiving the new approximate location of the communication device and the request for a higher resolution map, the communication device conveys (809) the request and the more accurate location to the system infrastructure over a wireless communication resource in accordance with known techniques. Some time after such conveyance, the communication device receives (811) the higher resolution map from the system infrastructure and displays (813) the newly received map to the device user. The communication device then eventually receives (815), from the user, an indication on the higher resolution map corresponding to the accurate location of the communication device. As discussed above, the user may also enter a textual description of the location and/or other textual or graphical information further identifying the device's location. When the communication device is located above the ground (e.g., in an upper floor of a high rise building), the location received from the user preferably includes information indicating a height or vertical position of the communication device.

After receiving the location and any other supporting information from the user, the communication device conveys (817) the location and supporting information, if any, to the system infrastructure over a wireless communication resource in accordance with known techniques, preferably for subsequent delivery to a target wireline or wireless device, and the logic flow ends (819).

FIG. 9 is a logic flow diagram 900 of steps executed by a communication device to assist a system infrastructure of a wireless communication system in accurately locating the communication device in accordance with yet another embodiment of the present invention. The logic flow begins (901) when the communication device receives (903) a map of an area that includes an approximate location of the communication device as determined by the system infrastructure in accordance with known techniques. The communication device stores (905) the map in memory for future use.

Some time after receiving and storing the map, the communication device receives (907) a request from the system infrastructure for an accurate location of the communication device. Responsive to the request, the communication device displays (909) the stored map and preferably the request to the device user. The communication device then eventually receives (911), from the device user, an indication on the map corresponding to the accurate location of the communication device. The communication device transmits (913) the accurate location to the system infrastructure, preferably in the form of a modified representation of the map that includes an indicator at the representative location of the communication device on the map, and the logic flow ends (915). The embodiment described with respect to FIG. 9 thus provides for provision of the map to the communication device prior to the device's receipt of a request for a more accurate location of the device. Such an embodiment may be utilized when the system controller is periodically determining the device's location and conveying updated maps to the communication device in anticipation of an upcoming request for the communication device's accurate location.

The present invention encompasses a method and apparatus for accurately locating a communication device in a wireless communication system. With this invention, wireless communication devices may be accurately located without substantially increasing the cost of such devices. By relying on manual input from a user of the wireless device, the present invention, in contrast to its strictly automated counterparts, provides a very precise location of the communication device in all directions (i.e., horizontally and vertically), as may be needed in an emergency or in some other situation in which a party desiring the location of a wireless device desires to meet personally with the user of the wireless device. Further, by using a map as the interface for the wireless device user to preferably input the device's location and for the target device user to view, in representative form, the wireless device's location, the present invention affords both users the ability to visually relate the wireless device's location with other known structures. Lastly, by also providing for the determination of the target device's location in accordance with an alternative embodiment, the present invention enables the system infrastructure to provide supplemental information (such as directions to the wireless device's location or general information, such as the city, state, and/or country in which the wireless device is presently located) to the target device depending on the distance between the target device and the wireless device.

While the foregoing constitute certain preferred and alternative embodiments of the present invention, it is to be understood that the invention is not limited thereto and that in light of the present disclosure, various other embodiments will be apparent to persons skilled in the art. Accordingly, it is to be recognized that changes can be made without departing from the scope of the invention as particularly pointed out and distinctly claimed in the appended claims which shall be construed to encompass all legal equivalents thereof.

What is claimed is:

1. A method for a system infrastructure of a wireless communication system to accurately locate a communication device in the wireless communication system, the method comprising the steps of:
determining an approximate geographic location of the communication device;
transmitting to the communication device, based on the approximate geographic location, at least a request for a more accurate geographic location of the communication device;
receiving from the communication device the more accurate geographic location; and
conveying the more accurate geographic location to a target device.

2. The method of claim 1, further comprising the step of, prior to the step of determining the approximate geographic location of the communication device, receiving a request for a geographic location of the communication device from a requesting device, the request identifying the target device.

3. The method of claim 2, wherein the requesting device is the target device.

4. The method of claim 2, wherein the requesting device is the communication device.

5. The method of claim 1, wherein the step of transmitting further comprises the step of transmitting to the communication device a map of an area that includes the approximate geographic location of the communication device.

6. The method of claim 5, wherein the step of receiving the more accurate geographic location comprises the step of receiving information identifying a location of the communication device on the map.

7. The method of claim 6, wherein the information identifying a location of the communication device on the map comprises a modified representation of the map indicating the location of the communication device.

8. The method of claim 7, wherein the information identifying a location of the communication device on the map further comprises textual information and graphical information further identifying the location of the communication device.

9. The method of claim 5, wherein the step of receiving the more accurate geographic location further comprises the step of receiving information identifying a second approximate location of the communication device on the map and a request for a second map corresponding to an area that includes the second approximate location, the second map being of a higher resolution than the map of the area that includes the approximate geographic location of the communication device, and wherein the method further comprises the step of transmitting the second map to the communication device.

10. The method of claim 9, wherein the step of receiving the more accurate geographic location further comprises the step of receiving information identifying a location of the communication device on the second map.

11. The method of claim 1, wherein the step of transmitting further comprises the step of transmitting to the communication device a textual description of an area that includes the approximate geographic location of the communication device.

12. The method of claim 1, wherein the step of determining an approximate geographic location of the communication device comprises the steps of:
transmitting a request to the communication device for the approximate geographic location; and
receiving the approximate geographic location from the communication device responsive to the transmitted request.

13. The method of claim 1, wherein the step of conveying the more accurate geographic location to the target device comprises the step of conveying a map to the target device, wherein the map indicates the more accurate geographic location.

14. The method of claim 1, wherein the step of conveying the more accurate geographic location to the target device comprises the step of conveying a textual description of the more accurate geographic location to the target device.

15. The method of claim 1, wherein the more accurate geographic location includes information indicating a height of the communication device.

16. The method of claim 1, further comprising the steps of:
determining a location of the target device; and
conveying supplemental information related to both the location of the target device and the more accurate geographic location of the communication device to the target device.

17. The method of claim 16, wherein the supplemental information is based on a distance between the communication device and the target device.

18. The method of claim 17, wherein the supplemental information comprises at least one of a city, a state, and a country when the communication device is located a substantial distance from the target device.

19. The method of claim 16, wherein the supplemental information comprises at least one of directions to the more accurate geographic location of the communication device from the location of the target device, an approximate distance between the more accurate geographic location of the communication device and the location of the target device, and an approximate commute time between the location of the target device and the more accurate geographic location of the communication device.

20. The method of claim 1, further comprising the steps of:
prior to the step of transmitting at least a request:
determining whether the approximate geographic location of the communication device is different than a previous approximate geographic location of the communication device; and
when the approximate geographic location of the communication device is different than a previous approximate geographic location of the communication device, automatically transmitting a map to the communication device, wherein the map corresponds to an area including the approximate geographic location of the communication device.

21. The method of claim 20, wherein the step of receiving the more accurate geographic location comprises the step of receiving information identifying a location of the communication device on the map.

22. A method for a communication device to assist a system infrastructure of a wireless communication system in providing an accurate geographic location of the communication device to a target device, the method comprising the steps of:
receiving, from the system infrastructure, at least a request for an accurate geographic location of the communication device;
displaying the request to a user of the communication device;
receiving, from the user, the accurate geographic location of the communication device; and
transmitting the accurate geographic location to the system infrastructure for subsequent delivery to the target device.

23. The method of claim 22, wherein the step of receiving at least a request further comprises the step of receiving a map of an area that includes an approximate location of the communication device.

24. The method of claim 23, wherein the step of displaying further comprises the step of displaying the map to the user.

25. The method of claim 24, wherein the step of receiving the accurate geographic location further comprises the step of receiving an indication on the map corresponding to a location of the communication device.

26. The method of claim 25, wherein the step of transmitting the accurate geographic location further comprises the step of transmitting a modified representation of the map that includes the indication corresponding to the location of the communication device.

27. The method of claim 24, wherein the step of receiving the accurate geographic location further comprises the steps of:
receiving an indication on the map corresponding to a second approximate location of the communication device, the second approximate location being more accurate than the approximate location; and
receiving a request for a second map corresponding to an area that includes the second approximate location of the communication device, the second map being of a higher resolution than the map of the area that includes the approximate location of the communication device.

28. The method of claim 27, wherein the step of transmitting the accurate geographic location further comprises the step of transmitting the second approximate location of the communication device and the request for the second map.

29. The method of claim 28, further comprising the steps of:
receiving the second map;
displaying the second map to the user; and
receiving, from the user, an indication on the second map corresponding to a location of the communication device to produce the accurate geographic location of the communication device.

30. The method of claim 29, wherein the step of transmitting the accurate geographic location comprises the step of transmitting a modified representation of the second map that includes the indication corresponding to the location of the communication device.

31. The method of claim 22, wherein the accurate geographic location of the communication device includes information indicating a height of the communication device.

32. The method of claim 22, further comprising the steps of:
prior to receiving at least the request,
receiving a map of an area that includes an approximate geographic location of the communication device; and
storing the map in a memory of the communication device;
wherein the step of displaying comprises the step of automatically displaying the map responsive to receiving the request and wherein the step of receiving the accurate geographic location comprises the step of receiving an indication on the map corresponding to a location of the communication device.

33. A method for a communication device to assist a system infrastructure of a wireless communication system in providing an accurate geographic location of the communication device to a target device, the method comprising the steps of:
receiving, from the system infrastructure, a request for an accurate geographic location of the communication device and a map of an area that includes an approximate geographic location of the communication device;
displaying at least the map to a user of the communication device;
receiving, from the user, an indication on the map corresponding to a location of the communication device; and
conveying the location of the communication device to the system infrastructure for subsequent delivery to the target device.

34. The method of claim 33, wherein the location of the communication device comprises information indicating a height of the communication device.

35. A method for a communication device to assist a system infrastructure of a wireless communication system in providing an accurate geographic location of the communication device to a target device, the method comprising the steps of:
receiving, from the system infrastructure, a request for an accurate geographic location of the communication device and a first map of an area that includes a first approximate geographic location of the communication device;
displaying at least the first map to a user of the communication device;
receiving, from the user, an indication on the first map corresponding to a second approximate geographic location of the communication device, the second approximate geographic location being more accurate than the first approximate geographic location;
conveying the second approximate geographic location and a request for a second map to the system infrastructure;
receiving the second map from the system infrastructure, the second map corresponding to an area that includes the second approximate geographic location and being of a higher resolution than the first map;
displaying the second map to the user of the communication device;
receiving, from the user, an indication on the second map corresponding to a location of the communication device; and
conveying the location of the communication device to the system infrastructure for subsequent delivery to the target device.

36. A communication device comprising:
a receiver for receiving, from a system infrastructure of a wireless communication system, at least a request for an accurate geographic location of the communication device;
a display, operably coupled to the receiver, for displaying the request to a user of the communication device;
a user input device for receiving, from the user, information corresponding to the accurate geographic location of the communication device; and
a transmitter, operably coupled to the user input device, for transmitting the accurate geographic location to the system infrastructure for subsequent delivery to a target device.

37. The communication device of claim 36, wherein the at least a request includes a map of an area that includes an approximate location of the communication device.

38. The communication device of claim 37, wherein the display further displays the map.

39. The communication device of claim 38, wherein the information corresponding to the accurate geographic location of the communication device comprises an indication on the map corresponding to a location of the communication device.

40. The communication device of claim 36, wherein the user input device comprises at least one of a keypad, a computer mouse, a touchpad, a touchscreen, a trackball, and a keyboard.

41. A communication device comprising:
a receiver for receiving, from a system infrastructure of a wireless communication system, a request for an accurate geographic location of the communication device and a map of an area that includes an approximate geographic location of the communication device;
a display, operably coupled to the receiver, for displaying at least the map to a user of the communication device;
a user input device for receiving, from the user, an indication on the map corresponding to a location of the communication device; and
a transmitter, operably coupled to the user input device, for transmitting the location of the communication device to the system infrastructure.

42. The communication device of claim 41, wherein the user input device comprises at least one of a keypad, a computer mouse, a touchpad, a touchscreen, a trackball, and a keyboard.
